(19) United States
(12) Patent Application Publication
(10) Pub. No.: US 2008/0107098 A1
(43) Pub. Date: May 8, 2008

(54) MULTISLOT-MODE AUTOMATIC FREQUENCY CORRECTION APPARATUS, SYSTEMS, AND METHODS

(76) Inventors: Paul Spencer, Modiin (IL); Yaron Segalov, Tel-Aviv (IL)

Correspondence Address: SCHWEGMAN, LUNDBERG & WOESSNER, P.A., P.O. BOX 2938, MINNEAPOLIS, MN, 55402, US

(21) Appl. No.: 11/557,579

(22) Filed: Nov. 8, 2006

(51) Int. Cl. H04B 7/212

(52) U.S. Cl. 370/347

(57) ABSTRACT

Embodiments herein may sense a measure of signal quality at a sub-channel associated with each of a set of allocated timeslots as frames associated with a data block are received at a wireless, packet-switched receiver. For each received frame, a selected allocated timeslot may be chosen from the set of allocated timeslots. The selected allocated timeslot may be chosen as having a highest likelihood among the set of allocated timeslots of containing coherent energy. A frequency offset may be calculated using information from the selected allocated timeslot. The frequency offset may be stored and used in subsequent frequency offset correction operations. Other embodiments may be described and claimed.

### TECHNICAL FIELD

Various embodiments described herein relate to digital communications generally, including apparatus, systems, and methods used in wireless communications.

### BACKGROUND INFORMATION

An evolving family of standards, specifications, and technical reports is being developed by the Third Generation Partnership Project (3GPP™) to define parameters associated with second and third generation wireless communication systems. These systems include a Global System for Mobile communication (GSM) and data access technologies such as General Packet Radio Service (GPRS) and Enhanced Data rates for GSM Evolution (EDGE). The acronyms GSM, GPRS, and EDGE are subsumed in “GSM EDGE radio access network (GERAN).” Additional information regarding these technologies may be found in European Telecommunications Standards Institute (ETSI) Technical Specification TS 101 855 V8.17.0, Digital Cellular Telecommunications System (Phase 2+); Technical Specifications and Technical Reports for a GERAN-based 3GPP System (3GPP TS 01.01 version 8.17.0 Release 1999) (published June 2005). Additional information regarding the 3GPP™ may be found at http://www.3gpp.org/.

Current GERAN standardizations may use modulation and coding schemes (MCSs) that include a one-third rate convolution coding operation followed by puncturing to a desired code rate. These MCSs may be denoted MCS1 thru MCS9. A resulting punctured block may be interleaved across several time-division multiple-access (TDMA) frames. For example, the block may be divided into four bursts and the bursts may then be transmitted in four consecutive time division multiple access (TDMA) frames. Each TDMA frame may comprise a number of time slices or “timeslots.”

In GSM packet mode, a mobile station (MS) may be configured to work in multislot mode. Multislot mode may allocate a number of timeslots, referred to as a “multislot,” to an MS. A typical MS may be capable of receiving a multislot comprising four timeslots from an eight-timeslot TDMA frame.

Frequency synchronization between a base station (BS) and an MS may be accomplished by estimation of a frequency offset based on data samples received in these timeslots. However, several issues may arise. Processing every received, allocated timeslot may result in a large processing requirement in a typical frequency offset estimator. For example, a frequency offset estimator utilizing two million instructions per second (MIPS) of processing power may require eight MIPS for four slots. That requirement may be comparable to an eight phase-shift keyed (8PSK) equalizer requiring approximately ten MIPS, and may therefore be impractical or expensive.

A second issue is that some allocated timeslots may not contain data blocks. This phenomenon is sometimes referred to as a “discontinuous transmission” (DTX) case. Some standards, for example, may only require that a BS transmit a minimum of one data block on at least one allocated timeslot once every 78 TDMA frames. A simple strategy of using the same timeslot for frequency offset estimation for each frame may not produce good frequency offset calculations under such circumstances.

### BRIEF DESCRIPTION OF THE DRAWINGS

FIG. 1 is a wireless system TDMA timeslot diagram according to various embodiments.

FIG. 2 is a block diagram of an apparatus and a system according to various embodiments.

FIG. 3 is a flow diagram illustrating several methods according to various embodiments.

FIG. 4 is a block diagram of a computer readable medium (CRM) according to various embodiments.

### DETAILED DESCRIPTION

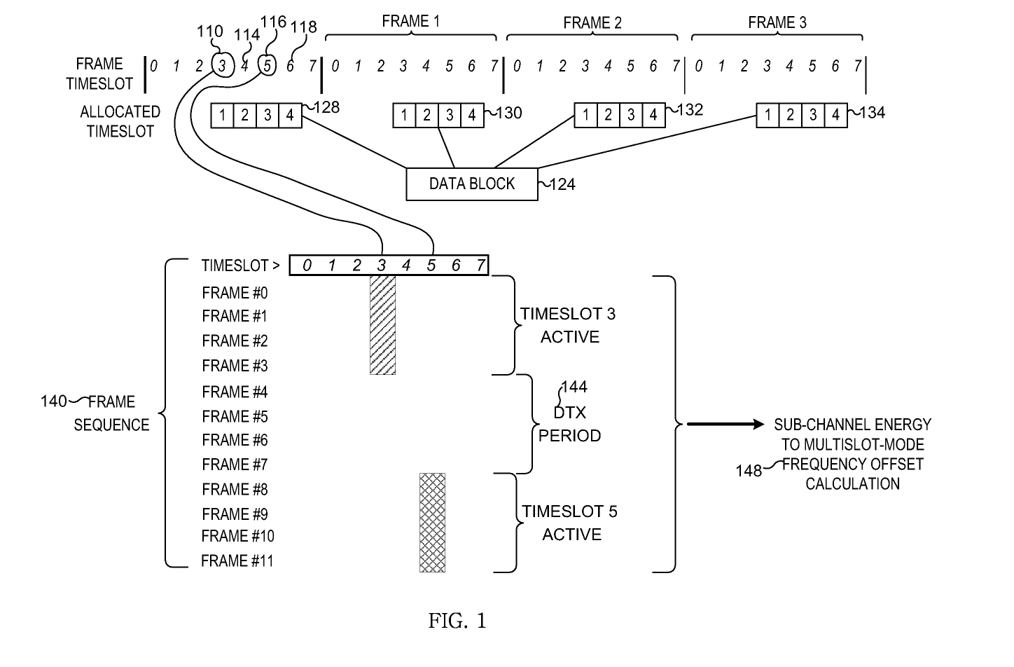

FIG. 1 is a wireless system TDMA timeslot diagram according to various embodiments disclosed herein. Some embodiments may compare a measure of signal quality sensed at a timeslot (e.g., the timeslot #3 110) allocated to a receiver to measures of signal quality associated with other timeslots (e.g., the timeslots #4 114, #5 116, and #6 118) allocated to the receiver. The comparison may be used to select a most probable active timeslot. “Most probable active timeslot” in this context means a sub-channel associated with an allocated timeslot that is most likely to contain coherent energy.

Data from the most probable active timeslot may be used to calculate a frequency offset between the receiver and a transmitter used to transmit a data block 124. The data block 124 may comprise multislots 128, 130, 132, and 134. Some embodiments herein may operate with wireless systems using time division framing formats other than the format shown in FIG. 1.

As an example frame sequence 140 shows, not all timeslots may be active for every frame. The timeslot #3 110 is active during frames 0-3 in the example frame sequence 140. The timeslot #5 116 is active during frames 8-11. During a DTX period 144 at frames 4-7, however, no timeslots are active. Embodiments herein may select data from the most probable active timeslot to use in a frequency offset calculation 148. A likelihood of using noise (e.g., during the DTX period 144) or data from a low-quality signal in the frequency offset calculation 148 may be reduced thereby.

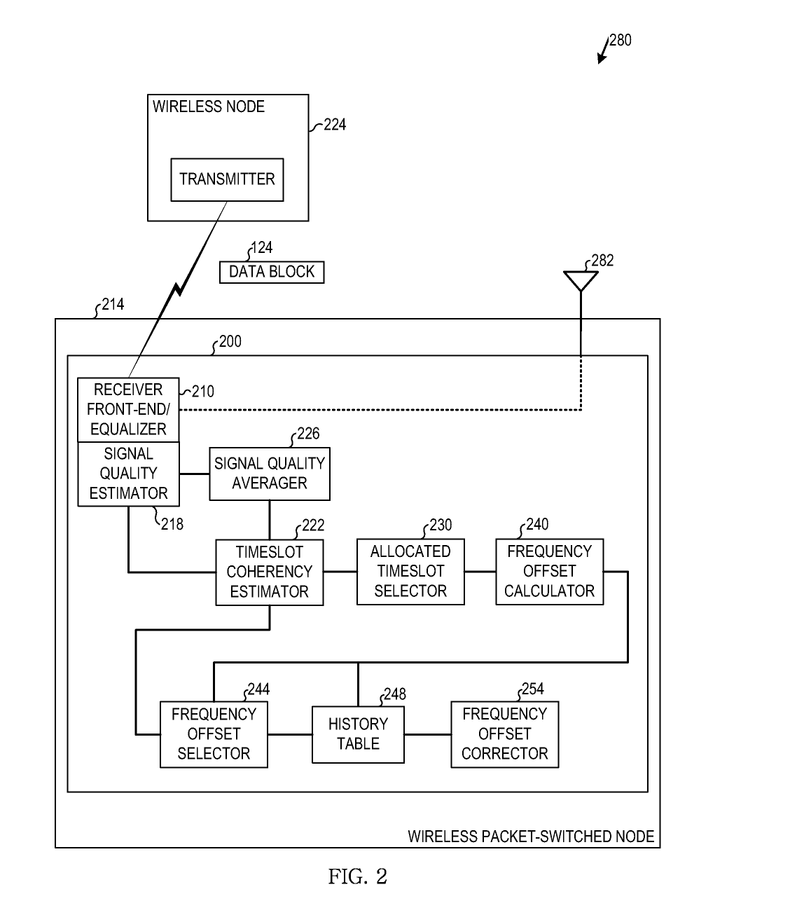

FIG. 2 is a block diagram of an apparatus 200 and a system 280 according to various embodiments. A receiver front-end and equalizer 210 may be associated with a wireless, packet-switched node 214. A signal quality estimator 218 may be coupled to the receiver front-end and equalizer 210. The signal quality estimator 218 may sense a measure of signal quality at a sub-channel associated with each of a set of allocated timeslots (e.g., the timeslots 110, 114, 116, and 118 of FIG. 1).

The measure of signal quality may comprise a channel-to-interference ratio (CIR), a carrier to interference-plus-noise ratio (CINR), a bit error probability (BEP), or a soft-sum equalizer output, among other measures. The measures of signal quality may be sensed as frames associated with a data block (e.g., the data block 124 of FIG. 1) are received. The frames may comprise the allocated timeslots.

The apparatus 200 may also include a timeslot coherency estimator 222 coupled to the signal quality estimator 218. The timeslot coherency estimator 222 may estimate a relative level of coherent energy associated with each of the allocated timeslots on a per-frame basis. The coherent energy may comprise a modulation component of a signal received at the wireless, packet-switched node 214 from a transmitting node 224. The modulation component may encode the data block 124.

A signal quality averager 226 may be operationally coupled to the timeslot coherency estimator 222. The signal quality averager 226 may calculate a frame-to-frame running average of the measure of signal quality for each of the allocated timeslots. The frame-to-frame running average may be used by the timeslot coherency estimator 222 to estimate the relative level of coherent energy associated with each of the allocated timeslots. Some embodiments may use other measures to determine the relative level of coherent energy associated with each of the allocated timeslots.

The apparatus 200 may further include an allocated timeslot selector 230 coupled to the timeslot coherency estimator 222. The allocated timeslot selector 230 may choose a selected allocated timeslot. The selection may be based upon the estimate of the relative level of coherent energy associated with each of the allocated timeslots, among other measures. Information from the sub-channel associated with the selected allocated timeslot may be used to calculate a frequency offset between the wireless, packet-switched node 214 and the transmitting node 224.

The apparatus 200 may also include a frequency offset calculator 240 coupled to the allocated timeslot selector 230. The frequency offset calculator 240 may calculate the frequency offset between the wireless, packet-switched node 214 and the transmitting node 224.

A frequency offset selector 244 may be coupled to the frequency offset calculator 240. The frequency offset selector 244 may store one or more frequency offset values for use in a frequency offset correction operation. The frequency offset values may be stored in a history table 248 operationally coupled to the frequency offset selector. In some embodiments, the frequency offset values may be stored if a function of the measure of signal quality associated with the selected allocated timeslot is greater than a threshold value. In an example embodiment, the function of the measure of signal quality associated with the selected allocated timeslot may comprise an average of values of the measure of signal quality, wherein one value is sensed for each frame of the received data block 124. In the case of CIR being used as the measure of signal quality, for example, the frequency offset values may be stored if the average CIR is within a range of about −20 dB to about 3 dB. Other functions of the measure of signal quality and other signal quality metrics may be used. The range of threshold values that may trigger the storing of the frequency offset values may vary accordingly.

The apparatus 200 may further include a frequency offset corrector 254 coupled to the history table 248. The frequency offset corrector 254 may perform a frequency offset correction operation using the frequency offset values stored in the history table 248.

In another embodiment, a system 280 may include one or more of the apparatus 200. The system 280 may also include an antenna 282. The antenna 282 may be operationally coupled to the signal quality estimator 218 via a receiver front-end and equalizer 210. The antenna 282 may comprise a patch antenna, an omnidirectional antenna, a beam antenna, a slot antenna, a monopole antenna, or a dipole antenna, among other types. The antenna 282 may receive the frames associated with the data block 124.

Any of the components previously described can be implemented in a number of ways, including embodiments in software. Thus, the timeslots 110, 114, 116, 118; the data block 124; the multislots 128, 130, 132, 134; the frame sequence 140; the DTX period 144; the frequency offset calculation 148; the apparatus 200; the receiver front-end and equalizer 210; the nodes 214, 224; the signal quality estimator 218; the timeslot coherency estimator 222; the signal quality averager 226; the allocated timeslot selector 230; the frequency offset calculator 240; the frequency offset selector 244; the history table 248; the frequency offset corrector 254; the system 280; and the antenna 282 may all be characterized as “modules” herein.

The modules may include hardware circuitry, single or multi-processor circuits, memory circuits, software program modules and objects, firmware, and combinations thereof, as desired by the architect of the apparatus 200 and the system 280 and as appropriate for particular implementations of various embodiments.

The apparatus and systems of various embodiments may be useful in applications other than selecting data from a most probable active timeslot in a received data block to calculate a frequency offset between a receiver and a transmitter used to transmit the data block. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 players), vehicles, medical devices (e.g., heart monitor, blood pressure monitor, etc.) and others. Some embodiments may include a number of methods.

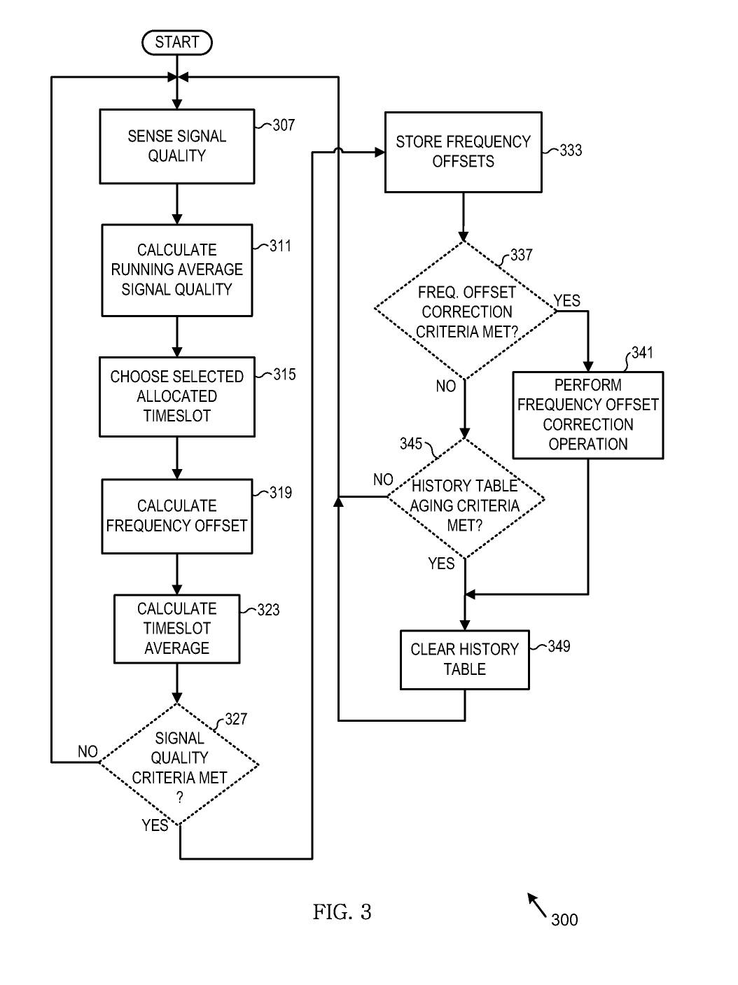

FIG. 3 is a flow diagram illustrating several methods according to various embodiments. In one example, a method 300 may select one of a set of timeslots allocated to a wireless packet-switched TDMA receiver to use in a frequency offset calculation. A selected allocated timeslot may be chosen as an allocated timeslot with a highest likelihood among the set of allocated timeslots of containing coherent energy. The coherent energy may comprise a modulation component of a signal received at the receiver from a transmitter. The modulation component may encode a data block transmitted to the receiver.

The method 300 may commence at block 307 with sensing a measure of signal quality at each of a series of TDMA sub-channels as the data block is received at the wireless, packet-switched receiver. The measure of signal quality may comprise a channel-to-interference ratio (CIR), a carrier to interference-plus-noise ratio (CINR), a bit error probability (BEP), a soft-sum equalizer output, or a combination of these indices, among other measures.

Each of the sub-channels may comprise a TDMA timeslot allocated to the receiver. A TDMA frame may comprise several (e.g., eight) of such timeslots. The measure of signal quality may be used to select one of the allocated timeslots from each frame to supply information to use in a frequency offset calculation and in a subsequent frequency offset correction operation.

The method 300 may continue at block 311 with calculating a frame-to-frame running average of the measure of signal quality for each of the set of allocated timeslots. The running average may be calculated after each frame is received and before a subsequent frame is received. The method 300 may also include choosing a timeslot as the selected allocated timeslot, at block 315. The selected allocated timeslot may be chosen as an allocated timeslot with a highest running average of the measure of signal quality for each frame subsequent to a first frame of the data block.

The method 300 may include calculating a frequency offset using information received at a sub-channel associated with the selected allocated timeslot, at block 319. The frequency offset may comprise a difference in frequency between the receiver and the transmitter used to transmit the data block.

The method 300 may also include calculating a timeslot average of values of the measure of signal quality for each selected allocated timeslot, at block 323. That is, an average may be calculated using values of the measure of signal quality associated with the selected allocated timeslot, one value sensed for each frame of the received data block. Thus, for example, a four-frame data block may present four values of the measure of signal quality for each allocated timeslot. The four values may be averaged to create the timeslot average for selected allocated timeslots.

The method 300 may further include storing one or more of the frequency offsets calculated during receipt of the data block for the selected allocated timeslot, at block 333. In some embodiments, the frequency offsets may be stored in a history table. In some embodiments, the frequency offsets may be stored conditionally according to a first condition, at block 327. For example, frequency offsets may be stored if the timeslot average calculated at block 323 is greater than a first threshold value. In the case of CIR being used as the measure of signal quality, for example, the frequency offset values may be stored if the average CIR is within a range of about −20 dB to about 3 dB. Other functions of the measure of signal quality and other signal quality metrics may be used. The range of threshold values that may trigger the storing of the frequency offset values may vary accordingly.

For example, a frequency offset calculated for a frame may be stored if the measure of signal quality for a selected allocated timeslot associated with the frame is greater than a second threshold value. In the case of CIR being used as the measure of signal quality, for example, a frequency offset value may be stored if the average CIR is within a range of about −17 dB to about 6 dB. Other criteria for determining whether a calculated frequency offset is of sufficient quality to be stored for use in a subsequent frequency offset correction operation may be possible. If such criteria are not met, the method 300 may loop to block 307 and repeat.

The method 300 may continue at block 341 with performing the frequency offset correction operation. In some embodiments the frequency offset correction operation may be initiated based upon a second condition, at block 337. For example, the frequency offset correction operation may be performed if a number of entries in the history table reaches a third threshold value. In an embodiment, the third threshold value may fall within a range of about 1-32 entries. Some embodiments may use other threshold values. In an alternate embodiment, the frequency offset correction operation may be performed based upon a compound condition. For example, the correction operation may be performed if the number of entries in the history table reaches a fourth threshold value (e.g., the third threshold value selected from a range of 1-32 entries) and an earliest-entered value in the history table has aged by a time corresponding to a number of received frames equal to a fifth threshold value. In an embodiment, the fifth threshold value may be selected from a range of about 100-500 frames. Other embodiments may use other threshold values.

In some embodiments, the frequency offset correction may be based upon a weighted average of frequency offset values stored in the history table. The average may be weighted according to a value of the measure of signal quality associated with the selected allocated timeslot at a time when the frequency offset associated with the selected allocated timeslot was calculated.

The method 300 may also include clearing entries from the history table following the frequency offset correction operation, at block 349. Some embodiments may clear an aged entry from the history table based upon criteria at decision block 345, even if a frequency offset operation is not performed. The aged entry may be cleared based upon an expiration of a defined amount of time of residence in the history table or based upon a defined number of events. For example, an entry may be cleared from the history table after a time corresponding to a number of received frames equal to a sixth threshold value. In an embodiment, the sixth threshold value may be selected from a range of about 100-500 frames. Other embodiments may use other threshold values. After clearing the history table, or if the history table aging criteria are not met, the method 300 may repeat beginning at block 307.

It may be possible to execute the activities described herein in an order other than the order described. And, various activities described with respect to the methods identified herein can be executed in repetitive, serial, or parallel fashion.

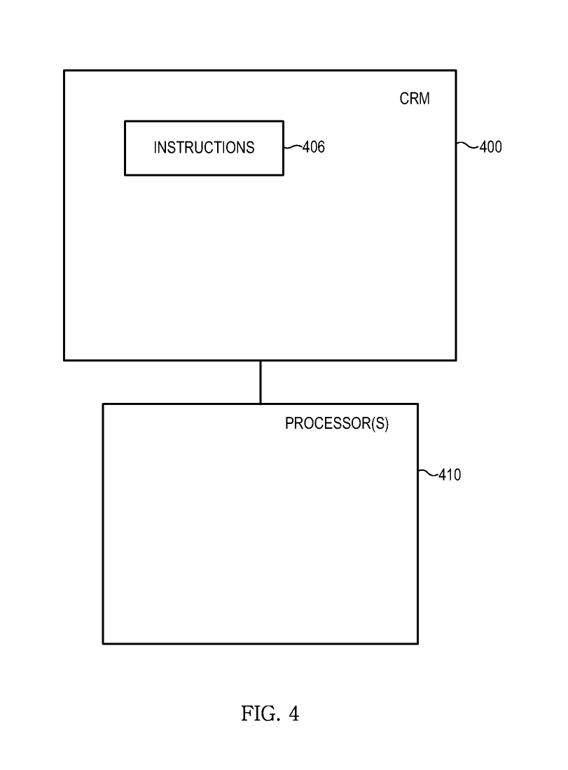

A software program may be launched from a computer-readable medium (CRM) in a computer-based system to execute functions defined in the software program. Various programming languages may be employed to create software programs designed to implement and perform the methods disclosed herein. The programs may be structured in an object-oriented format using an object-oriented language such as Java or C++. Alternatively, the programs may be structured in a procedure-oriented format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment. Thus, other embodiments may be realized, as discussed regarding FIG. 4 below.

FIG. 4 is a block diagram of a CRM 400 according to various embodiments of the invention. Examples of such embodiments may comprise a memory system, a magnetic or optical disk, or some other storage device. The CRM 400 may contain instructions 406 which, when accessed, result in one or more processors 410 performing any of the activities previously described, including those discussed with respect to the method 300 noted above.

The apparatus, systems, and methods disclosed herein may perform frequency offset adjustment operations based upon frequency offset calculations using information from sub-channels associated with a most probable active timeslot for each received data frame. Decreased processor loading and shorter frequency convergence times may result.

Although the inventive concept may include embodiments described in the exemplary context of an ETSI GERAN standard implementation or an IEEE standard 802.xx implementation (e.g., 802.11, 802.11a, 802.11b, 802.11e, 802.11g, 802.16, etc.), the claims are not so limited. Additional information regarding the IEEE 802.11 standard may be found in “ANSI/IEEE Std. 802.11, Information technology—Telecommunications and information exchange between systems—Local and metropolitan area networks—Specific requirements—Part 11: Wireless LAN Medium Access Control (MAC) and Physical Layer (PHY) Specifications” (published 1999; reaffirmed June 2003). Additional information regarding the IEEE 802.11a protocol standard may be found in IEEE Std 802.11a, Supplement to IEEE Standard for Information technology—Telecommunications and information exchange between systems—Local and metropolitan area networks—Specific requirements Part 11: Wireless LAN Medium Access Control (MAC) and Physical Layer (PHY) specifications—High-speed Physical Layer in the 5 GHz Band (published 1999; reaffirmed Jun. 12, 2003). Additional information regarding the IEEE 802.11b protocol standard may be found in IEEE Std 802.11b, Supplement to IEEE Standard for Information technology—Telecommunications and information exchange between systems—Local and metropolitan area networks—Specific requirements—Part 11: Wireless LAN Medium Access Control (MAC) and Physical Layer (PHY) specifications: Higher-Speed Physical Layer Extension in the 2.4 GHz Band (approved Sep. 16, 1999; reaffirmed Jun. 12, 2003). Additional information regarding the IEEE 802.11E standard may be found in “IEEE 802.11e Standard for Information technology—Telecommunications and information exchange between systems—Local and metropolitan area networks—Specific requirements Part 11: Wireless LAN Medium Access Control (MAC) and Physical Layer (PHY) specifications: Amendment 8: Medium Access Control (MAC) Quality of Service Enhancements (published 2005). Additional information regarding the IEEE 802.11g protocol standard may be found in IEEE Std 802.11g™, IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band (approved Jun. 12, 2003).

Embodiments of the present invention may be implemented as part of any wired or wireless system. Examples may also include embodiments comprising multi-carrier wireless communication channels (e.g., orthogonal frequency division multiplexing (OFDM), discrete multitone (DMT), etc.) such as may be used within a wireless personal area network (WPAN), a wireless local area network (WLAN), a wireless metropolitan area network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a signal quality estimator associated with a wireless, packet-switched node to sense a measure of signal quality at a sub-channel associated with each timeslot of a set of allocated timeslots as frames associated with a data block are received, wherein the frames comprise the allocated timeslots;
a timeslot coherency estimator coupled to the signal quality estimator to estimate a relative level of coherent energy associated with the each timeslot of the set of allocated timeslots on a per-frame basis; and
an allocated timeslot selector coupled to the timeslot coherency estimator to choose a selected allocated timeslot, wherein information from the sub-channel associated with the selected allocated timeslot is used to calculate a frequency offset between the wireless, packet-switched node and a transmitting node.

2. The apparatus of claim 1, wherein the measure of signal quality comprises at least one of a channel-to-interference ratio (CIR), a carrier to interference-plus-noise ratio (CINR), a bit error probability (BEP), or a soft-sum equalizer output.

3. The apparatus of claim 1, further including:
a signal quality averager operationally coupled to the timeslot coherency estimator to calculate a frame-to-frame running average of the measure of signal quality for the each timeslot of the set of allocated timeslots.

4. The apparatus of claim 1, further including:
a frequency offset calculator coupled to the allocated timeslot selector to calculate the frequency offset.

5. The apparatus of claim 4, further including:
a frequency offset selector coupled to the frequency offset calculator to store at least one value associated with the frequency offset for use in a frequency offset correction operation if a function of the measure of signal quality associated with the selected allocated timeslot is greater than a threshold value.

6. The apparatus of claim 5, wherein the function of the measure of signal quality associated with the selected allocated timeslot comprises an average of values of the measure of signal quality, one value sensed for each frame of the received data block.

7. The apparatus of claim 5, further including:
a history table operationally coupled to the frequency offset selector to store the at least one value associated with the frequency offset.

8. The apparatus of claim 7, further including:
a frequency offset corrector coupled to the history table to perform a frequency offset correction operation using the at least one value associated with the frequency offset.

9. A system, including:
a signal quality estimator associated with a wireless, packet-switched node to sense a measure of signal quality at a sub-channel associated with each timeslot of a set of allocated timeslots as frames associated with a data block are received, wherein the frames comprise the allocated timeslots;
a timeslot coherency estimator coupled to the signal quality estimator to estimate a relative level of coherent energy associated with the each timeslot of the set of allocated timeslots on a per-frame basis;
an allocated timeslot selector coupled to the timeslot coherency estimator to choose a selected allocated timeslot, wherein information from the sub-channel associated with the selected allocated timeslot is used to calculate a frequency offset between the wireless, packet-switched node and a transmitting node; and
an omnidirectional antenna operationally coupled to the signal quality estimator to receive the frames associated with the data block.

10. The system of claim 9, wherein the coherent energy comprises a modulation component of a signal received at the wireless, packet-switched node from the transmitting node, the modulation component to encode the data block.

11. The system of claim 9, further including:
a frequency offset corrector to perform a frequency offset correction operation using the frequency offset.

12. A method, including:
sensing a measure of signal quality at a sub-channel associated with each timeslot of a set of allocated timeslots as frames associated with a data block are received at a wireless, packet-switched receiver, wherein the frames comprise the allocated timeslots; and
for each of the frames associated with the data block:
choosing a selected allocated timeslot from the set of allocated timeslots, wherein the selected allocated timeslot has a highest likelihood among the set of allocated timeslots of containing coherent energy; and
calculating a frequency offset using information received at a selected sub-channel associated with the selected allocated timeslot.

13. The method of claim 12, further including:
calculating a frame-to-frame running average of the measure of signal quality for each timeslot of the set of allocated timeslots after each frame is received and before a subsequent frame is received; and
for each frame subsequent to a first frame of the data block, choosing a timeslot with a highest running average of the measure of signal quality as the selected allocated timeslot.

14. The method of claim 12, further including:
for each selected allocated timeslot, calculating a timeslot average of values of the measure of signal quality, wherein one value of the measure of signal quality is sensed for each frame of the received data block; and
storing each of the frequency offsets calculated during receipt of the data block for the each selected allocated timeslot to use in a frequency offset correction operation if the timeslot average is greater than a first threshold value.

15. The method of claim 12, further including:
for each selected allocated timeslot, storing at least one of the frequency offsets calculated during receipt of the data block to use in a frequency offset correction operation if the measure of signal quality associated with the each selected allocated timeslot is greater than a second threshold value.

16. The method of claim 12, further including:
for each selected allocated timeslot, storing at least one of the frequency offsets calculated during receipt of the data block to use in a frequency offset correction operation.

17. The method of claim 12, wherein the frequency offset comprises a difference in frequency between the receiver and a transmitter used to transmit the data block.

18. The method of claim 17, wherein the coherent energy comprises a modulation component of a signal received at the receiver from the transmitter, the modulation component to encode the data block.

19. The method of claim 12, wherein the measure of signal quality comprises at least one of a channel-to-interference ratio (CIR), a carrier to interference-plus-noise ratio (CINR), a bit error probability (BEP), or a soft-sum equalizer output.

20. The method of claim 12, further including:
storing the frequency offset in a history table for use in a frequency offset correction operation.

21. The method of claim 20, further including:
performing the frequency offset correction operation if a number of entries in the history table reaches a third threshold value; and
clearing all entries from the history table.

22. The method of claim 20, further including:
performing the frequency offset correction operation if the number of entries in the history table reaches a fourth threshold value and an earliest-entered value in the history table has aged by a time corresponding to a number of received frames equal to a fifth threshold value; and
clearing all entries from the history table.

23. The method of claim 20, further including:
clearing an aged entry from the history table if the aged entry has aged by a time corresponding to a number of received frames equal to a sixth threshold value.

24. The method of claim 20, wherein the frequency offset correction operation is based upon a weighted average of frequency offset values stored in the history table, the average weighted according to a value of the measure of signal quality associated with a selected allocated timeslot at a time when the frequency offset associated with the selected allocated timeslot was calculated.

25. A computer-readable medium having instructions, wherein the instructions, when executed, result in at least one processor performing:
sensing a measure of signal quality at a sub-channel associated with each timeslot of a set of allocated timeslots as frames associated with a data block are received at a wireless, packet-switched receiver, wherein the frames comprise the allocated timeslots; and
for each of the frames associated with the data block:
choosing a selected allocated timeslot from the set of allocated timeslots, wherein the selected allocated timeslot has a highest likelihood among the set of allocated timeslots of containing coherent energy; and
calculating a frequency offset using information from the selected allocated timeslot.

26. The computer-readable medium of claim 25, wherein the instructions, when executed, result in the at least one processor performing:
calculating a frame-to-frame running average of the measure of signal quality for the each timeslot of the set of allocated timeslots after each frame is received and before a subsequent frame is received; and
for each frame subsequent to a first frame of the data block, choosing a timeslot with a highest running average of the measure of signal quality as the selected allocated timeslot.

27. The computer-readable medium of claim 25, wherein the instructions, when executed, result in the at least one processor performing:
storing in a history table at least one of the frequency offsets calculated across the data block for the each timeslot of the set of allocated timeslots for a later use in a frequency offset correction operation;
performing the frequency offset correction operation if a number of entries in the history table reaches a threshold value; and
clearing all entries from the history table.
